(19) United States
(12) Patent Application Publication
(10) Pub. No.: US 2024/0375384 A1
(43) Pub. Date: Nov. 14, 2024

(54) METHOD OF MANUFACTURING THERMOPLASTIC CARBON FIBER SHEET AND THERMOPLASTIC CARBON FIBER SHEET MANUFACTURED THEREBY

(71) Applicants: Hyundai Motor Company, Seoul (KR); Kia Corporation, Seoul (KR)

(72) Inventor: Yong Beom Lee, Seoul (KR)

(73) Assignees: Hyundai Motor Company, Seoul (KR); Kia Corporation, Seoul (KR)

(21) Appl. No.: 18/368,043

(22) Filed: Sep. 14, 2023

(30) Foreign Application Priority Data
May 8, 2023 (KR) 10-2023-0059039

(51) Int. Cl. B32B 27/12; B32B 27/36

(52) U.S. Cl. CPC B32B 27/12; B32B 27/365; B32B 2262/106

(57) ABSTRACT

Disclosed are a method of manufacturing a thermoplastic carbon fiber sheet having superior reproducibility of a pattern formed on a sheet surface and a thermoplastic carbon fiber sheet manufactured by the method. The method of manufacturing a thermoplastic carbon fiber sheet includes preparing a first thermoplastic carbon fiber by impregnating an admixture of a nickel-plated first carbon fiber and a non-plated second carbon fiber with a first thermoplastic resin; preparing a second thermoplastic carbon fiber by impregnating a non-plated second carbon fiber with a second thermoplastic resin, manufacturing first carbon fiber chips by cutting the first thermoplastic carbon fiber and preparing the second carbon fiber chips by cutting the second thermoplastic carbon fiber; forming a pattern layer by distributing the first carbon fiber chips on an electromagnetic field plate, and molding a sheet by distributing the second carbon fiber chips on the pattern layer and applying heat and pressure.

### CROSS-REFERENCE TO RELATED APPLICATION

This application claims, under 35 U.S.C. § 119 (a), the benefit of priority from Korean Patent Application No. 10-2023-0059039, filed on May 8, 2023, the entire contents of which are incorporated herein by reference.

### TECHNICAL FIELD

The present disclosure relates to a method of manufacturing a thermoplastic carbon fiber sheet having excellent pattern reproducibility and a thermoplastic carbon fiber sheet manufactured thereby.

### BACKGROUND

Conventionally, extruded sheets have been manufactured using thermosetting resin such as unsaturated polyester, vinyl ester, epoxy, etc., and are imparted with various patterns by applying sizing-treated carbon fiber roving onto the surface thereof. For example, in the process of manufacturing an extruded sheet with a thermosetting resin, when fiber cut through a cutting roller penetrates the resin, it is applied onto the uppermost layer, followed by drying and aging in a roll form for 2 to 7 days.

After completion of aging, the resulting sheet has viscosity at an appropriate level through a high-temperature/high-pressure pressing process. For example, the sheet is manufactured into various products through cutting to a size suitable for a molded product and then pressing using heat and pressure and curing. Here, the pressing process may be performed at a temperature of 120 to 200° C. depending on the resin used.

Meanwhile, for a thermosetting resin such as unsaturated polyester or vinyl ester serving as a matrix resin, volatile organic compound (VOC) emission and odor standards are unsatisfactory due to use of styrene as a reaction diluent. Instead, the use of epoxy as the thermosetting resin makes it possible to overcome such problems, but there are disadvantages in that it is expensive, deteriorates workability, and is difficult to recycle.

Moreover, during manufacture of the sheet, processes of cutting and applying carbon fiber proceed in an automatic mode, but the processing environment is very poor due to flying of the cut fiber and odor generation of the resin.

Recently, a sheet manufactured using a sheet molding compound (SMC) has improved formability and mechanical properties, and is thus applied not only to the construction and aerospace industries, but also to the interiors and exteriors of automobiles to improve luxury and marketability. Currently, these products are called Forged Carbon or Forged Composite.

Currently, however, it is difficult to reproducibly and uniformly form a pattern that meets the customer's design needs with the conventional manufacturing method.

Against the above background, it is necessary for a technique for manufacturing a sheet capable of attaining reproducibility of the surface pattern while improving the working environment and process.

### SUMMARY

In preferred aspects, provided are a method of manufacturing a thermoplastic carbon fiber sheet capable of improving a working environment and process and also attaining reproducibility of a pattern formed on a sheet surface, and a thermoplastic carbon fiber sheet manufactured by the method.

In one aspect, the disclosure provides a method of manufacturing a thermoplastic carbon fiber sheet, including steps of: preparing a first thermoplastic carbon fiber by impregnating an admixture including a nickel-plated first carbon fiber and a non-plated second carbon fiber with a first thermoplastic resin; preparing a second thermoplastic carbon fiber by impregnating a non-plated second carbon fiber with a second thermoplastic resin; manufacturing first carbon fiber chips by cutting the first thermoplastic carbon fiber and preparing second carbon fiber chips by cutting the second thermoplastic carbon fiber; forming a pattern layer by distributing the first carbon fiber chips on an electromagnetic field plate; and molding a sheet by distributing the second carbon fiber chips on the pattern layer and applying heat and pressure.

The term “a nickel-plated carbon fiber” as used herein refers to a carbon fiber plated or coated at least in part or whole surface of the fiber. The plating or coating part (e.g., layer) may include nickel metallic components, or compounds or salts including nickel, and may be formed from Ni containing precursors.

The term “non-plated carbon fiber” as used herein refers to a carbon-fiber which is not treated (e.g., coated or plated).

The first carbon fiber may be prepared by immersing carbon fiber particles having Sn/Pd nuclei formed on surfaces thereof in an electroless plating solution including a nickel salt, a reducing agent, and a complexing agent.

The first carbon fiber may be prepared by immersing the carbon fiber particles in an electroless plating solution having a pH of about 8 to 10 for about 3 to 5 minutes.

The first thermoplastic carbon fiber may include the first carbon fiber and the second carbon fiber mixed in a mass ratio of about 3:7 to 7:3.

The first thermoplastic resin and the second thermoplastic resin may include polycarbonate (PC).

The first thermoplastic carbon fiber and the second thermoplastic carbon fiber may be a unidirectional carbon fiber fabric in tape form.

The first carbon fiber chips and the second carbon fiber chips may have a width of about 1.5 to 25 mm and a length of about 1 to 80 mm.

In forming the pattern layer, the pattern layer may be formed using the first carbon fiber chips including nickel and an electromagnetic field pattern formed in the electromagnetic field plate.

Molding the sheet may be performed for about 10 to 20 minutes at a temperature of about 250 to 300° C. under a pressure of about 20 to 40 bar.

Also, in one aspect, the disclosure provides a thermoplastic carbon fiber sheet manufactured by the method described above.

Further, the disclosure provides an automotive part including the thermoplastic carbon fiber sheet described above.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings, which are given hereinbelow by way of illustration only, and thus are not limitative of the present invention, and wherein:

FIG. 1 shows an exemplary process of manufacturing a thermoplastic carbon fiber sheet according to an exemplary embodiment of the present invention;

FIG. 2 schematically shows exemplary carbon fiber chips in which carbon fiber is cut;

FIG. 3 shows optical microscope images of the surfaces of thermoplastic carbon fiber sheets according to Examples and Comparative Examples; and

FIGS. 4A and 4B are optical microscope images showing the surface of the part according to Comparative Example.

### DETAILED DESCRIPTION

The above and other objects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the disclosure and to sufficiently transfer the spirit of the present invention to those skilled in the art.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular”, “automotive” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

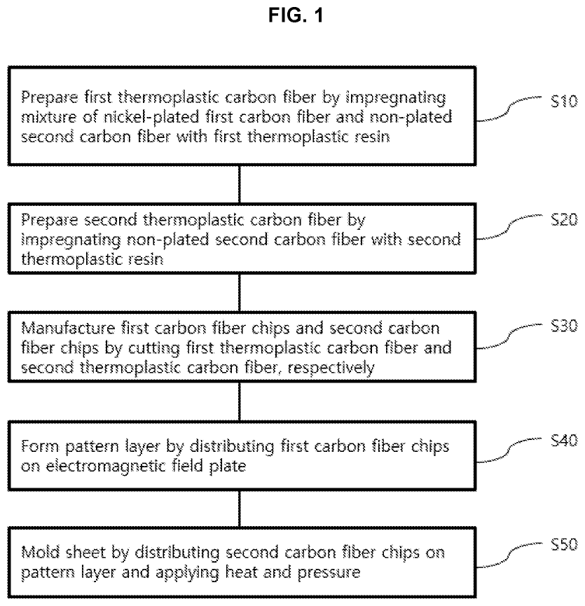

The present invention provides a method of manufacturing a thermoplastic carbon fiber sheet. Hereinafter, the present invention will be described in more detail with reference to the accompanying drawings. FIG. 1 shows an exemplary process of manufacturing a thermoplastic carbon fiber sheet according to an exemplary embodiment of the present invention.

As shown in FIG. 1, the method of manufacturing the thermoplastic carbon fiber sheet according to an exemplary embodiment of the present invention may include preparing a first thermoplastic carbon fiber by impregnating an admixture including a nickel-plated first carbon fiber and a non-plated second carbon fiber with a first thermoplastic resin (S10); preparing a second thermoplastic carbon fiber by impregnating a non-plated second carbon fiber with a second thermoplastic resin (S20); manufacturing first carbon fiber chips by cutting the first thermoplastic carbon fiber and preparing second carbon fiber chips by cutting the second thermoplastic carbon fiber (S30); forming a pattern layer by distributing the first carbon fiber chips on an electromagnetic field plate (S40); and molding a sheet by distributing the second carbon fiber chips on the pattern layer and then applying heat and pressure (S50).

Individual steps of the method of manufacturing the thermoplastic carbon fiber sheet according to an exemplary embodiment of the present invention are described below.

In S10, a first thermoplastic carbon fiber is prepared.

The first thermoplastic carbon fiber is obtained by impregnating an admixture including a nickel-plated first carbon fiber and a non-plated second carbon fiber with a first thermoplastic resin.

The nickel-plated first carbon fiber may be prepared by immersing carbon fiber particles having Sn/Pd nuclei on surfaces thereof in an electroless plating solution including a nickel salt, a reducing agent, and a complexing agent. For example, NiCl₂ or NiSO₄ may be suitably used as the nickel salt, Na₃C₆H₅O₇ or NaCO₂CH₃ may be suitably used as the reducing agent, and NaH₂PO₂ may be suitably used as the complexing agent. The other examples of the reducing agent may include hydrazine or borohydride compounds.

In the first carbon fiber, nickel ions of the nickel salt form a nickel film on the surfaces of the carbon fiber particles by the reducing agent included in the electroless plating solution.

The carbon fiber particles used for electroless plating are preferably subjected to pretreatment that forms metal nuclei after removing surface impurities to activate the fiber surface before electroless plating. Through the pretreatment process, Sn/Pd nuclei may be formed on the surfaces of the carbon fiber particles, and the Sn/Pd nuclei formed on the surface of the carbon fiber may promote deposition of metallic nickel.

The electroless plating solution may have a pH of about 8 to 10. Particularly, the nickel-plated first carbon fiber may be prepared by immersing carbon fiber particles in the electroless plating solution at a temperature of about 85 to 95° C. for about 3 to 5 minutes. As such, when the immersion time is less than 3 minutes, the amount of the nickel-phosphorus alloy formed on the surface of the carbon fiber may be small due to very short autocatalytic reaction. On the other hand, when the immersion time is greater than about 5 minutes, pits may be generated in the surface of the carbon fiber due to the nickel-phosphorus alloy formed in a large amount, which may cause a phenomenon in which the interfacial bonding force with the matrix resin is decreased. Also, in the pH range of the electroless plating solution, when the pH thereof is less than about 8, plating may not be performed due to insufficient acidity, whereas if the pH thereof is greater than about 10, plating agglomeration may occur due to excessive plating.

In the first thermoplastic carbon fiber, the mixture of the nickel-plated first carbon fiber and the non-plated second carbon fiber in a mass ratio of about 3:7 to 7:3 may be impregnated with the first thermoplastic resin. For example, the first thermoplastic resin may include polycarbonate (PC).

The first thermoplastic carbon fiber prepared in S10 may be a unidirectional carbon fiber fabric in tape form.

In S20, a second thermoplastic carbon fiber is prepared.

The second thermoplastic carbon fiber is obtained by impregnating a non-plated second carbon fiber with a second thermoplastic resin. For example, the second thermoplastic resin may include polycarbonate (PC).

The second thermoplastic carbon fiber prepared in S20 may be a unidirectional carbon fiber fabric, e.g., in tape form.

In S30, the first carbon fiber chips are manufactured by cutting the first thermoplastic carbon fiber with a cutting machine, and the second carbon fiber chips are manufactured by cutting the second thermoplastic carbon fiber.

The first carbon fiber chips and the second carbon fiber chips may have a width of about 1.5 to 25 mm and a length of about 1 to 80 mm.

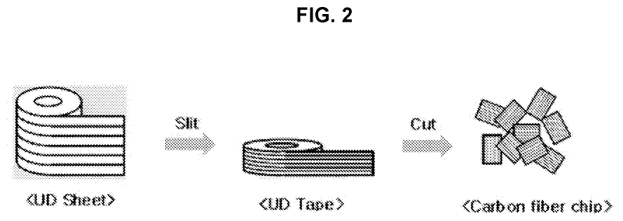

FIG. 2 schematically shows exemplary carbon fiber chips formed by cutting the carbon fiber.

As shown in FIG. 2, the first thermoplastic carbon fiber and the second thermoplastic carbon fiber may include a carbon fiber fabric in a state of being unidirectionally woven and wound in tape form.

Also, as shown in FIG. 2, the first carbon fiber chips and the second carbon fiber chips used in the present invention may be obtained by cutting the unidirectional carbon fiber fabric in tape form resulting from slitting of a unidirectional carbon fiber fabric in sheet form.

In S40, the pattern layer is formed by distributing the first carbon fiber chips on the electromagnetic field plate. Here, the electromagnetic field plate may be a plate capable of forming an electromagnetic field by power applied thereto.

In S40, a pattern layer having a pattern of the first carbon fiber chips including nickel may be formed depending on the electromagnetic field pattern formed in the electromagnetic field plate.

Finally, in S50, the thermoplastic carbon fiber sheet may be formed by distributing the second carbon fiber chips on the pattern layer and then applying heat and pressure to the top and bottom of the pattern layer on which the second carbon fiber chips are distributed.

Particularly, before the molding process in S50, a molding preparation process may be performed sequentially.

In certain embodiments, before distributing the second carbon fiber chips, an imide film may be placed on the pattern layer, and a plate-like lower mold may be placed on the imide film, followed by vertical inversion so that the pattern layer is located on the lower mold. Subsequently, the electromagnetic field plate located on the pattern layer is removed, after which a mold frame having an accommodation space therein is placed on the pattern layer.

Then, the second carbon fiber chips are distributed and charged in the mold frame, after which an imide film is placed on the second carbon fiber chips.

Subsequently, a plate-like upper mold is placed on the imide film, thereby completing molding preparation.

Finally, the thermoplastic carbon fiber sheet may be molded and manufactured by applying heat and pressure to the upper mold and the lower mold. Particularly, the molding process may be conducted for about 10 to 20 minutes at a temperature of about 250 to 300° C. under a pressure of about 20 to 40 bar. Thereafter, cooling to room temperature for at least about 30 minutes and then removal of the imide films and the molds are performed, thereby completing molding of the thermoplastic carbon fiber sheet.

Accordingly, a unique pattern may be represented on the surface of the thermoplastic carbon fiber sheet, and a stylish and luxurious texture may be provided.

In another aspect, the disclosure provides a thermoplastic carbon fiber sheet. The thermoplastic carbon fiber sheet according to the present invention may be manufactured by the manufacturing method described herein. The thermoplastic carbon fiber sheet may be variously applied to vehicle parts having a pattern capable of providing a stylish and luxurious texture in appearance.

Still another aspect of the present invention provides an automotive part, and the automotive part includes the thermoplastic carbon fiber sheet.

The automotive part may be manufactured through the following method using the thermoplastic carbon fiber sheet.

Particularly, the thermoplastic carbon fiber sheet is cut to a size suitable for a part, and the thermoplastic carbon fiber sheet is preheated at a temperature of about 130 to 140° C. for about 3 to 5 minutes. Here, when the preheating temperature is less than about 130° C., the thermoplastic carbon fiber sheet may not be sufficiently preheated, making it difficult to seat the same in a mold, whereas when the preheating temperature is greater than 140° C., the thermoplastic carbon fiber sheet may be overheated and the pattern of the sheet may be deformed when moving to a mold.

Subsequently, the preheated thermoplastic carbon fiber sheet is charged in a mold and then molded at a temperature of about 270 to 290° C. for about 5 to 10 minutes. Here, when the molding temperature is less than 270° C., defects such as voids may occur due to insufficient melting of the polycarbonate resin, and bubbles may occur during painting. On the other hand, when the molding temperature is greater than about 290° C., it may be difficult to maintain the pattern of the thermoplastic carbon fiber sheet, and degradation of the resin may occur, resulting in deteriorated properties.

Subsequently, the molded product is taken out, burrs and the like are removed from the molded product, and quality inspections such as initial appearance and dimensions are performed.

Finally, the molded product is painted, ultimately completing production of the part.

### Example

A better understanding of the present invention may be obtained through the following examples. These examples are merely set forth to illustrate the present invention, and are not to be construed as limiting the scope of the present invention.

### Test Example 1: Amount Ratio of Electroless Nickel-Plated Carbon Fiber and Non-Plated Carbon Fiber

In order to confirm the effect of the amount ratio of electroless nickel-plated carbon fiber and non-plated carbon fiber used in a first thermoplastic carbon fiber according to an exemplary embodiment of the present invention on the patterning and formability of a sheet, thermoplastic carbon fiber sheets according to Examples and Comparative Examples were manufactured.

Subsequently, the surface of the thermoplastic carbon fiber sheet according to an exemplary embodiment of the present invention was closely observed using an optical microscope.

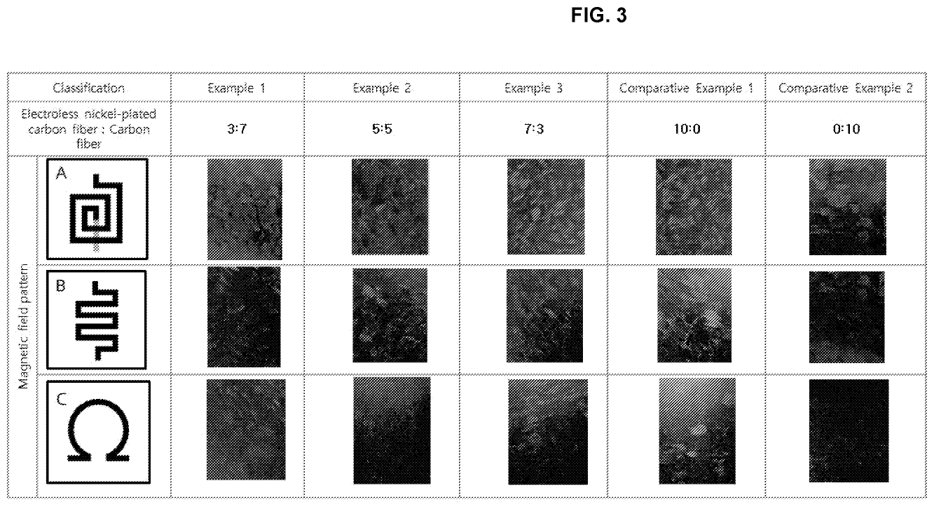

FIG. 3 shows optical microscope images of the surfaces of the thermoplastic carbon fiber sheets according to Examples and Comparative Examples.

Particularly, the thermoplastic carbon fiber sheets according to Examples and Comparative Examples were manufactured below.

### Examples 1 to 3

A first thermoplastic carbon fiber was prepared by impregnating an admixture of a nickel-plated first carbon fiber and a non-plated second carbon fiber in a mass ratio of 3:7 to 7:3 with polycarbonate (PC). Also, a second thermoplastic carbon fiber was prepared by impregnating a non-plated second carbon fiber with polycarbonate (PC).

Next, first carbon fiber chips and second carbon fiber chips were manufactured by cutting the first thermoplastic carbon fiber and the second thermoplastic carbon fiber, respectively.

Next, a pattern layer was formed by distributing 20 g of the first carbon fiber chips on an electromagnetic field plate. Here, the direction of a magnetic field pattern formed in the electromagnetic field plate is set as pattern A, B, or C shown in FIG. 3.

Finally, a thermoplastic carbon fiber sheet (297*210 mm, 0.7-0.8 t, 55-60 g) was molded and manufactured by distributing 40 g of the second carbon fiber chips on the pattern layer using a mold and then applying heat and pressure to the mold. Here, the molding was conducted for 10 to 20 minutes using a press at 20 to 40 bar at a temperature of 280° C.

### Comparative Example 1

A thermoplastic carbon fiber sheet was manufactured in the same manner as in Example 1, with the exception that the first thermoplastic carbon fiber obtained by impregnating the nickel-plated first carbon fiber with polycarbonate (PC) was used alone.

### Comparative Example 2

A thermoplastic carbon fiber sheet was manufactured in the same manner as in Example 1, with the exception that the first thermoplastic carbon fiber obtained by impregnating the non-plated second carbon fiber with polycarbonate (PC) was used alone.

As shown in FIG. 3, among magnetic field patterns A, B, and C according to exemplary embodiments of the present invention, pattern A was the best in forming a carbon (forged) pattern. Therefore, various patterns can be designed by appropriately changing the magnetic field pattern formed in the electromagnetic field plate. Moreover, a three-dimensional carbon (forged) pattern can be formed with an increase in the amount of the electroless nickel-plated first carbon fiber in the first thermoplastic carbon fiber.

### Test Example 2: Molding of Part with Carbon (Forged) Pattern

In order to confirm the effect of the process of forming a pattern layer using an electromagnetic field on parts, parts were molded and manufactured below using the thermoplastic carbon fiber sheets according to Example and Comparative Example, and performance of the parts was measured.

### Example

A part having a carbon (forged) pattern was molded and manufactured using the thermoplastic carbon fiber sheet according to Example 2. Here, in the thermoplastic carbon fiber sheet according to Example 2, the first thermoplastic carbon fiber in which the mixture of nickel-plated first carbon fiber and non-plated second carbon fiber in a ratio of 5:5 was impregnated with polycarbonate (PC) was used, and pattern A shown in FIG. 3 was used as the direction of the magnetic field pattern formed in the electromagnetic field plate.

Particularly, the part was manufactured by appropriately cutting the thermoplastic carbon fiber sheet according to Example 2 to a size suitable for a part; performing preheating at a temperature of 130 to 140° C. for 3 minutes and then charging in a mold; performing molding for 5 minutes at a temperature of 270 to 290° C.; taking out a molded product and removing burrs from the molded product; and painting the molded product using a glossy or low-gloss clear coat.

### Comparative Example

A part was molded and manufactured using, as a raw material, carbon fiber chips manufactured by cutting the first thermoplastic carbon fiber in which the mixture of nickel-plated carbon fiber and non-plated carbon fiber in a ratio of 5:5 was impregnated with polycarbonate (PC). The part according to Comparative Example was not subjected to a patterning process using the electromagnetic field plate during manufacture.

Particularly, the part according to Comparative Example was manufactured in a manner in which the carbon fiber chips were placed in a weight similar to that of the corresponding part in a mold and compressed at a temperature of 270 to 290° C. for 5 minutes, the resulting molded product was taken out, burrs were removed therefrom, and the molded product was painted with a glossy or low-gloss clear coat.

Based on the results of evaluation of performance of the parts, the part according to Example can be minimized in defects such as voids by applying sufficient pressure during sheet production and part molding. Thus, the part may be suitable for application to medium/large parts.

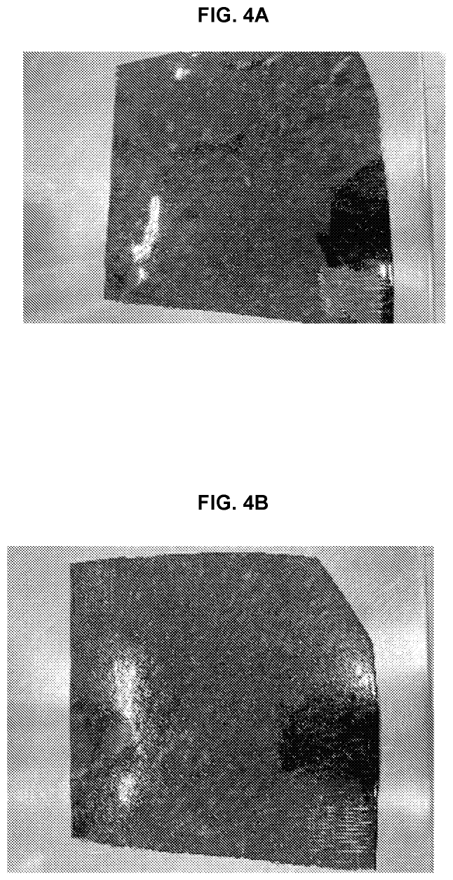

FIGS. 4A and 4B are optical microscope images showing the part according to Comparative Example. As shown in FIGS. 4A and 4B, the part according to Comparative Example had defects such as voids in the molded product, resulting in substantial amounts of generated bubbles during painting and poor initial adhesion.

Therefore, in a method of manufacturing a thermoplastic carbon fiber sheet according to various exemplary embodiments of the present invention, a molded product capable of attaining high reproducibility of a carbon pattern and shielding electromagnetic waves by applying carbon fiber chips including nickel and an electromagnetic field pattern formed in an electromagnetic field plate can be manufactured.

In addition, the method of manufacturing the thermoplastic carbon fiber sheet according to various exemplary embodiments of the present invention can alleviate problems such as VOC emission, odor generation, and low recyclability, which have been problematic in the related art, by applying polycarbonate (PC) as a matrix resin.

In addition, the method of manufacturing the thermoplastic carbon fiber sheet according to various exemplary embodiments of the present invention uses carbon fiber chips in which thermoplastic carbon fiber is cut, thereby improving the working environment and process without fiber flying and odor emission.

As is apparent from the above description, in a method of manufacturing a thermoplastic carbon fiber sheet according to various exemplary embodiments of the present invention, carbon fiber chips including nickel and an electromagnetic field pattern formed in an electromagnetic field plate are applied, thereby making it possible to manufacture a molded product exhibiting superior reproducibility of the carbon pattern and capable of shielding electromagnetic waves.

In the method of manufacturing the thermoplastic carbon fiber sheet according to various exemplary embodiments of the present invention, polycarbonate (PC) is used as a matrix resin, thereby alleviating problems such as VOC emission, odor generation, and low recyclability, which have been problematic in the related art.

In the method of manufacturing the thermoplastic carbon fiber sheet according to various exemplary embodiments of the present invention, carbon fiber chips in which thermoplastic carbon fiber is cut are used, thereby improving a working environment and process without fiber flying and odor emission.

The effects of the present invention are not limited to the above-mentioned effects. It should be understood that the effects of the present invention include all effects that can be inferred from the description of the present invention.

Although exemplary embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A method of manufacturing a thermoplastic carbon fiber sheet, comprising:
preparing a first thermoplastic carbon fiber by impregnating an admixture comprising a nickel-plated first carbon fiber and a non-plated second carbon fiber with a first thermoplastic resin;
preparing a second thermoplastic carbon fiber by impregnating a non-plated second carbon fiber with a second thermoplastic resin;
manufacturing first carbon fiber chips by cutting the first thermoplastic carbon fiber and preparing second carbon fiber chips by cutting the second thermoplastic carbon fiber;
forming a pattern layer by distributing the first carbon fiber chips on an electromagnetic field plate; and
molding a sheet by distributing the second carbon fiber chips on the pattern layer and applying heat and pressure.

2. The method of claim 1, wherein the first carbon fiber is prepared by immersing carbon fiber particles having Sn/Pd nuclei formed on surfaces thereof in an electroless plating solution comprising a nickel salt, a reducing agent, and a complexing agent.

3. The method of claim 2, wherein the first carbon fiber is prepared by immersing the carbon fiber particles in an electroless plating solution having a pH of about 8 to 10 for 3 to 5 minutes.

4. The method of claim 1, wherein the first thermoplastic carbon fiber comprises the first carbon fiber and the second carbon fiber mixed in a mass ratio of about 3:7 to 7:3.

5. The method of claim 1, wherein the first thermoplastic resin and the second thermoplastic resin comprise polycarbonate (PC).

6. The method of claim 1, wherein the first thermoplastic carbon fiber and the second thermoplastic carbon fiber are a unidirectional carbon fiber fabric in tape form.

7. The method of claim 1, wherein the first carbon fiber chips and the second carbon fiber chips have a width of about 1.5 to 25 mm and a length of about 1 to 80 mm.

8. The method of claim 1, wherein in forming the pattern layer, the pattern layer is formed using the first carbon fiber chips comprising nickel and an electromagnetic field pattern formed in the electromagnetic field plate.

9. The method of claim 1, wherein molding the sheet is performed for about 10 to 20 minutes at a temperature of about 250 to 300° C. under a pressure of about 20 to 40 bar.

10. A thermoplastic carbon fiber sheet manufactured by the method of claim 1.

11. An automotive part comprising the thermoplastic carbon fiber sheet of claim 10.
